(19) United States
(12) Patent Application Publication
(10) Pub. No.: US 2006/0144950 A1
(43) Pub. Date: Jul. 6, 2006

(54) Transceiver with image capture device

(76) Inventor: Alan Johnson, Surrey (GB)

Correspondence Address: HARRINGTON & SMITH, LLP, 4 RESEARCH DRIVE, SHELTON, CT, 06484-6212, US

(21) Appl. No.: 10/541,079

(22) PCT Filed: Dec. 18, 2003
(86) PCT No.: PCT/EP03/51070

§ 371 Date: Dec. 23, 2005

(30) Foreign Application Priority Data
Dec. 30, 2002 (GB) 0230295.8

(51) Int. Cl. G06K 7/10

(52) U.S. Cl. 235/472.02

(57) ABSTRACT

A communication terminal including a transceiver arranged to discontinuously transmit data from the terminal; an image sensor including a plurality of image-sensing regions, each image-sensing region being capable of being reset, and subsequently being read to provide data indicative of light incident on the image-sensing region since it was last reset; and image capture means coupled to the image capture device and arranged to capture image data from each of the image-sensing regions by resetting and subsequently reading the image-sensing regions, and being arranged to, when the transceiver is in operation for discontinuous data transmission, reset and/or read at least some of the image-sensing regions only when the transceiver is not transmitting data from the terminal.

This invention relates to communication terminals, such as mobile phones, that are equipped with image capture devices, such as charge coupled device (CCD) units.

It is becoming increasingly popular for mobile phones to include a camera. Typically such a phone allows its user to take a photograph using the camera and then to send the captured image over a mobile phone network to another person who can then display it on his terminal.

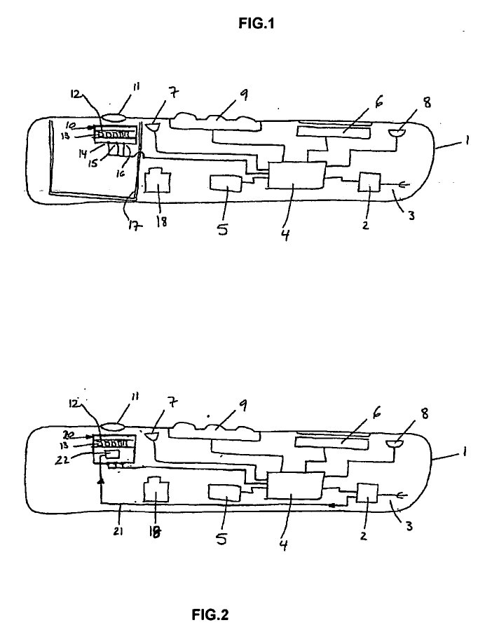

FIG. 1 is a schematic view of a mobile phone including a camera. The mobile phone of FIG. 1 includes a casing 1 inside which are a radio transceiver unit 2, having an antenna 3 for transmitting and receiving radio signals, and a control processor 4. The control processor 4 handles data processing and user interface functions of the phone. The control processor forms the data that is to be transmitted by the phone and then passes it to the transceiver for transmission. Data received by the transceiver is passed to the control processor. The casing also includes a memory 5 for storage purposes, a display 6 for displaying data to a user, a microphone 7 for receiving audio signals, and a loudspeaker 8 for generating audio signals. A keypad 9 is mounted on the outer surface of the housing 1 so that it can be operated by a user to provide input to the control processor 4. The phone is powered by a battery 18. A digital image capture device 10, serving as a camera, is mounted inside the casing and is directed outwards so that it can receive light incoming through a lens 11 integrated into the housing 1.

The image capture device 10 is connected to the control processor so that the control processor can obtain images from it. The image capture device comprises an image sensor 12 having large number of image-sensing regions 13 arranged in an array. In a monochrome camera each image-sensing region is used to form a pixel of the image. In a colour image sensor, the image-sensing regions are grouped into sets of adjacent red-, green- and blue-sensitive image-sensing regions, whose data are used together to form a colour pixel of the image. The control processor can initiate a read of the image sensor by means of a read input 14, and can then receive the state of the image-sensing regions via a data output 15. This provides an indication of the intensity of illumination of each image-sensing region since it was last reset. The control processor can reset the image-sensing regions by means of a reset input 16. A certain integration time must be allowed between each reset and the subsequent read in order for the image sensor to receive sufficient light to successfully acquire each pixel. The image sensor is typically a CCD unit.

The image sensor is sensitive to radio interference from the antenna, which tends to degrade the quality of the image that is received. For this reason, the antenna and the image sensor are normally spaced apart as far as possible, and a complex, expensive and volume-inefficient set of shielding cans (shown schematically at 17) are placed between the image sensor and the antenna. The shielding that is used adds considerably to the weight and volume of the phone, both of which are important considerations for potential purchasers. In addition, spacing the antenna and the image sensor apart results in severe design limitations.

One solution that has been proposed to avoid these problems is that the phone should be forced to enter a mode in which it cannot make or receive calls when the camera is in operation. However, this limits the functionality of the phone, since it is desirable that both functions can be used at once.

The idea of operating the camera only during the periods when the transceiver is not active has been considered. However, this is not generally practical because in a typical time division multiple access (TDMA) system the idle periods are not sufficiently long to allow the camera to acquire its pixels. For instance, the GSM (global system for mobile communications) TDMA system has frames 4.615 ms long, with eight 0.577 ms slots within the frame. In normal (single slot) GSM operation a phone uses only one of those slots, making it inactive for the other seven slots—i.e. for 4.038 ms per frame. In two-slot operation, as in GPRS (general packet radio service) the inactive time is 3.5 ms. In contrast, the integration time required for a CCD to acquire a pixel can be up to 66 ms. Therefore, it is not possible for this to be done during the time available between transmission slots.

There is a need for an improved way of integrating a camera with a radio transmitter in a device such as a mobile phone.

According to one aspect of the present invention there is provided a communication terminal comprising: a transceiver arranged to discontinuously transmit data from the terminal; an image sensor comprising a plurality of image-sensing regions, each image-sensing region being capable of being reset, and subsequently being read to provide data indicative of light incident on the image-sensing region since it was last reset; and image capture means coupled to the image capture device and arranged to capture image data from each of the image-sensing regions by resetting and subsequently reading the image-sensing regions, and being arranged to, when the transceiver is in operation for discontinuous data transmission, reset and/or read at least some of the image-sensing regions only when the transceiver is not transmitting data from the terminal.

According to a second aspect of the present invention there is provided a method of operating a communication terminal comprising: a transceiver arranged to discontinuously transmit data from the terminal; an Image sensor comprising a plurality of image-sensing regions, each image-sensing region being capable of being reset, and subsequently being read to provide data indicative of light incident on the image-sensing region since it was last reset; and image capture means coupled to the image capture device and arranged to capture image data from each of the image-sensing regions by resetting and subsequently reading the image-sensing regions, and being arranged to, when the transceiver is in operation for discontinuous data transmission, reset and/or read at least some of the image-sensing regions only when the transceiver is not transmitting data from the terminal; the method comprising the following steps: resetting at least some of the image-sensing regions when the transceiver is not transmitting data from the terminal; transmitting data from the terminal by means of the transceiver; and capturing image data from the said at least some of the image-sensing regions when the transceiver is not transmitting data from the terminal to obtain data indicative of light incident on the image-sensing region since the said resetting.

The image capture means may be arranged to reset at least some, or preferably all, of the image-sensing regions only when the transceiver is not transmitting data from the terminal. Alternatively, or in addition, the image capture means may be arranged to read at least some, or preferably all, of the image-sensing regions only when the transceiver is not transmitting data from the terminal.

The transceiver may be arranged to transmit data from the terminal according to a TDMA protocol. The transceiver may be arranged to wirelessly transmit the data from the terminal. The transceiver may be arranged to transmit the data from the terminal by radio.

The image sensor may be a CCD device.

The terminal may be capable of transmitting by way of the transceiver data representing a picture captured from the image-sensing regions.

The terminal is preferably such that the transceiver is capable of transmitting data from the terminal during the period between the image capture means resetting the image-sensing regions and the next successive reading of the image-sending regions. Thus the transceiver is preferably active between the reset operation and the subsequent read operation. The transceiver may be receiving data from outside the terminal during that period. Preferably the transceiver is active to transmit data in one or more slots in successive transmission frames, and the reset and read operations are performed whilst the transceiver continues that pattern.

The present invention will now be described by way of example with reference to the accompanying drawings.

In the drawings:

FIGS. 1 and 2 are a schematic cross-sections of mobile phones.

The inventors of the present invention have found that substantially all the degradation to the data from the image sensor that is due to interference from transmissions from the phone occurs during the read and/or reset phases.

Interference with the data during the integration phase has been found to be negligible. Since the read and reset phases are very short, they can be performed during the time within a frame when the transmitter of a TDMA phone is inactive. This is exploited in the phone of FIG. 2. The phone of FIG. 2 is generally similar to that of FIG. 1, but the image capture device 20 of the phone of FIG. 2 is synchronised with the transceiver 2 via a synchronisation link 21. This enables a local controller 22 of the image capture device to arrange that the image-sensing regions 13 of the image sensor 12 are reset and/or read only at times when the transceiver is not transmitting. As a result, the shielding between the camera and the transceiver and antenna can be done away with, or at least greatly reduced.

In FIG. 2 like components are numbered as for FIG. 1.

In the phone of FIG. 2 the image capture device comprises image sensor 12, which has individual image sensing regions 13, which operate in the same way as described above in connection with FIG. 1. The image capture device also comprises the local controller 22, which interfaces between the image sensor 12 and the read, data and reset connections 14 to 16.

In operation of the phone of FIG. 2, the local controller 22 receives synchronisation signals from the transceiver. This allows the local controller to determine when the transceiver will be in operation. For example, the transceiver could signal the local controller at the start of each frame, and could inform the local controller of which slots in the frame it is to be transmitting on.

The steps taken to capture an image using the camera are as follows.

First, a user aims the camera and initiates the taking of the picture, for example by pressing a key on the keypad 9. This signals the control processor that a picture is to be taken. The control processor signals a reset signal to input 16 of the image capture device. This signal is passed to the local controller 22.

The local controller waits until it can reset the image sensor without that operation overlapping with the transceiver transmitting. To do this it checks the information it has on the current state of the transceiver to establish whether there is currently at least the time period required to reset the image sensor available before the transceiver will be transmitting. The time required for a reset may, for instance, be 1 ms. if the transceiver will be transmitting during that period then the local controller 22 waits for a predetermined time, for instance 1 ms, and then repeats the check. Once it has established that the transceiver will not be transmitting for the period required to reset the image sensor, the local controller resets the image sensor.

After a predetermined time (e.g. 65 ms) the control processor signals a read signal to input 14 of the image capture device. This signal is passed to the local controller 22.

The local controller waits until it can read the image sensor and output the read data to the control processor without that operation overlapping with the transceiver transmitting. To do this it checks the information it has on the current state of the transceiver to establish whether there is currently at least the time period required to perform the read operation available before the transceiver will be transmitting. The time required for a read operation may, for instance, be 1 ms. If the transceiver will be transmitting during that period then the local controller 22 waits for a predetermined time, for instance 1 ms, and then repeats the check. Once it has established that the transceiver will not be transmitting for the period required to perform the read operation, the local controller performs the read operation by reading the state of each image-sensing region 13 and outputting that state to the control processor 4 via data output 15.

Depending on the operational details of the image sensor, it may be that one of the reset and read operations is insensitive to interference from the transceiver 2. In that case that operation need not be performed when the transceiver is not transmitting.

The split of functions between the control processor 4 and the local controller 22 may be varied. The local controller 22 could be fully integrated into the control processor 4.

The system described above is not limited to use with mobile phones. Cameras integrated in other devices that have data transmission capabilities that could interfere with an image sensor wireless transmitters could also benefit. Such data transmission capabilities are likely to be wireless data transmission capabilities and most probably radio data transmission capabilities, but wired data transmission could also cause interference, especially if it were of relatively high power. Examples of devices that could use the system described above include personal digital assistants (PDAs) having wireless LAN (local area network) capabilities, and dedicated cameras (e.g. webcams) that transmit pictures by wireless means.

The system described above is suitable for TDMA wireless devices and other wireless devices that transmit data discontinuously in such a way that the reset and read operations of the image sensor can be performed when transmission is in operation for discontinuous data transmission but at a time when data is not being transmitted.

The applicant hereby discloses in isolation each individual feature described herein and any combination of two or more such features, to the extent that such features or combinations are capable of being carried out based on the present specIfication as a whole in the light of the common general knowledge of a person skilled in the art, irrespective of whether such features or combinations of features solve any problems disclosed herein and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A communication terminal comprising:
a transceiver arranged to discontinuously transmit data from the terminal;
an image sensor comprising a plurality of image-sensing regions, each image-sensing region being capable of being reset, and subsequently being read to provide data indicative of light incident on the image-sensing region since it was last reset; and
image capture means coupled to the Image capture device and arranged to capture image data from each of the image-sensing regions by resetting and subsequently reading the image-sensing regions, and being arranged to, when the transceiver is in operation for discontinuous data transmission, reset and/or read at least some of the image-sensing regions only when the transceiver is not transmitting data from the terminal.

2. A communication terminal as claimed in claim 1, wherein the image capture means is arranged to reset at least some of the image-sensing regions only when the transceiver is not transmitting data from the terminal.

3. A communication terminal as claimed in claim 1, wherein the image capture means is arranged to reset all the image-sensing regions only when the transceiver is not transmitting data from the terminal.

4. A communication terminal as claimed in claim 1, wherein the image capture means is arranged to read at least some of the image-sensing regions only when the transceiver is not transmitting data from the terminal.

5. A communication terminal as claimed in claim 4, wherein the image capture means is arranged to read all the Image-sensing regions only when the transceiver is not transmitting data from the terminal.

6. A communication terminal as claimed in claim 1, wherein the transceiver is arranged to transmit data from the terminal according to a TDMA protocol.

7. A communication terminal as claimed in claim 1, wherein the transceiver is arranged to wirelessly transmit the data from the terminal.

8. A communication terminal as claimed in claim 7, wherein the transceiver is arranged to transmit the data from the terminal by radio.

9. A communication terminal as claimed in claim 1, wherein the image sensor is a CCD device.

10. A communication terminal as claimed in claim 1, wherein the terminal is capable of transmitting by way of the transceiver data representing a picture captured from the image-sensing regions.

11. A communication terminal as claimed in claim 1, the terminal being such that the transceiver is capable of transmitting data from the terminal during the period between the image capture means resetting the image-sensing regions and the next successive reading of the image-sending regions.

12. A method of operating a communication terminal comprising: a transceiver arranged to discontinuously transmit data from the terminal; an image sensor comprising a plurality of image-sensing regions, each image-sensing region being capable of being reset, and subsequently being read to provide data indicative of light incident on the image sensing region since it was last reset; and image capture means coupled to the image capture device and arranged to capture image data from each of the image-sensing regions by resetting and subsequently reading the image-sensing regions, and being arranged to, when the transceiver is in operation for discontinuous data transmission, reset and/or read at least some of the image-sensing regions only when the transceiver is not transmitting data from the terminal; the method comprising the following steps:
resetting at least some of the image-sensing regions when the transceiver is not transmitting data from the terminal;
transmitting data from the terminal by means of the transceiver; and capturing image data from the said at least some of the image-sensing regions when the transceiver is not transmitting data from the terminal to obtain data indicative of light incident on the image-sensing region since the said resetting.

13. (canceled)

14. (canceled)
